(19) United States
(12) Patent Application Publication
(10) Pub. No.: US 2020/0382922 A1
(43) Pub. Date: Dec. 3, 2020

(54) V2X PACKET FILTERING AND LATENCY SCHEDULING IN PHYSICAL LAYER DECODING

(71) Applicant: QUALCOMM Incorporated, San Diego, CA (US)

(72) Inventors: Hee Jun PARK, San Diego, CA (US); Assaf TOUBOUL, Netanya (IL); Shmuel VAGNER, Raanana (IL)

(21) Appl. No.: 15/931,088

(22) Filed: May 13, 2020

Related U.S. Application Data
(60) Provisional application No. 62/856,579, filed on Jun. 3, 2019.

(51) Int. Cl. H04W 4/40; H04L 29/06; H04L 29/08

(52) U.S. Cl. CPC H04W 4/40; H04W 84/18; H04L 69/321; H04L 69/22

(57) ABSTRACT

A method, apparatus, and computer-readable medium for wireless communication at a first UE, such as C-V2X. The apparatus receives a message comprising a control channel and a data channel from a second UE. The apparatus decodes, at the physical layer, a subset of fields of the control channel. The apparatus determines a priority of the message relative to the first UE based on the subset of fields and determines, at the physical layer, whether to decode the message based on the priority of the message relative to the first UE. The apparatus forwards the message to higher OSI layers for a next stage of decoding when a determination is made at the physical layer to decode the message. The apparatus skips the next stage of decoding of the message at the higher OSI layers when the determination is made at the physical layer not to decode the message.

### CROSS REFERENCE TO RELATED APPLICATION(S)

This application claims the benefit of U.S. Provisional Application Ser. No. 62/856,579, entitled “V2X Packet Filtering and Latency Scheduling in Physical Layer Decoding” and filed on Jun. 3, 2019, which is expressly incorporated by reference herein in its entirety.

### BACKGROUND

### Technical Field

The present disclosure relates generally to communication systems, and more particularly, to vehicle-to-vehicle (V2V), vehicle-to-everything (V2X), or other device-to-device (D2D) communication.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. Aspects of wireless communication may comprise direct communication between devices, such as in V2X and/or other D2D communication. There exists a need for further improvements in V2X and/or other D2D technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for cellular vehicle-to-everything (C-V2X) wireless communication at a first user equipment (UE). The apparatus receives, at a physical layer, a message from a second UE, the message comprising a control channel and a data channel. The apparatus decodes, at the physical layer, a subset of fields comprised in the control channel. The apparatus determines a priority of the message relative to the first UE based on the subset of fields decoded at the physical layer and determines, at the physical layer, whether to decode the message based on the priority of the message relative to the first UE. The apparatus forwards the message to higher open system interconnection (OSI) layers for a next stage of decoding when a determination is made at the physical layer to decode the message If the determination is made not to decode the message, the next stage of decoding may be skipped.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates an example of a sidelink slot structure.

FIG. 3 is a diagram illustrating an example of a first device and a second device involved in wireless communication based, e.g., on V2X and/or other device-to-device communication.

FIGS. 4A and 4B illustrate examples of V2X and/or other device-to-device communication.

FIG. 5 illustrate examples of modem chips.

FIG. 6 illustrates an example concurrent workload and corresponding power usage.

FIG. 7 illustrates examples of processing at a modem processor and an application processor based on different types of filtering and not filtering.

FIG. 8 illustrates examples of processing at OSI layers based on different types of filtering and not filtering.

FIG. 9 illustrates an example hardware processor and application processor for processing received packets.

FIG. 10 illustrates an example effective priority manager.

FIG. 11 illustrates an example of determining a latency budget for a packet.

FIG. 12 illustrates an example of processing received messages using filtering presented herein.

FIG. 13 illustrates an example of processing received messages using filtering presented herein.

FIG. 14 is a flowchart of a method of wireless communication.

FIG. 15 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

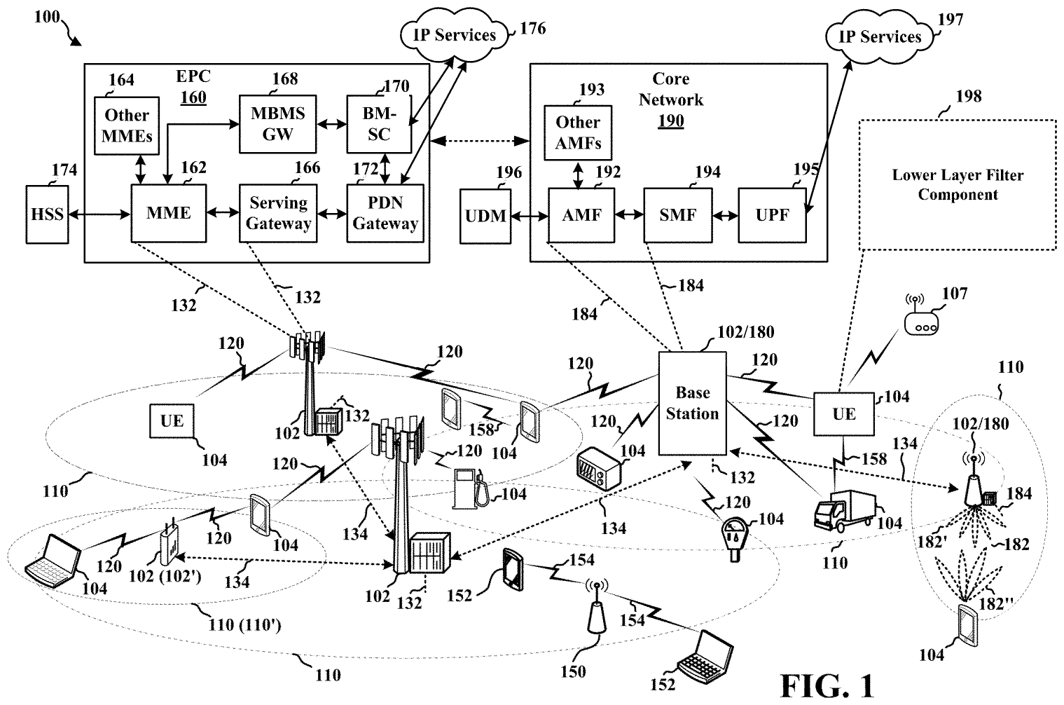

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and a Core Network (e.g., 5GC) 190. The base stations 102 may include macro cells (high power cellular base station) and/or small cells (low power cellular base station). The macro cells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for NR (collectively referred to as Next Generation RAN (NG-RAN)) may interface with Core Network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or Core Network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Frequency range bands include frequency range 1 (FR1), which includes frequency bands below 7.225 GHz, and frequency range 2 (FR2), which includes frequency bands above 24.250 GHz. Communications using the mmW/near mmW radio frequency (RF) band (e.g., 3 GHz-300 GHz) has extremely high path loss and a short range. Base stations/UEs may operate within one or more frequency range bands. The mmW base station 180 may utilize beamforming 182 with the UE 104 to compensate for the extremely high path loss and short range. The base station 180 and the UE 104 may each include a plurality of antennas, such as antenna elements, antenna panels, and/or antenna arrays to facilitate the beamforming.

Devices may use beamforming to transmit and receive communication. For example, FIG. 1 illustrates that a base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although beamformed signals are illustrated between UE 104 and base station 102/180, aspects of beamforming may similarly may be applied by UE 104 or RSU 107 to communicate with another UE 104 or RSU 107, such as based on V2X, V2V, or D2D communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The Core Network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the Core Network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or Core Network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

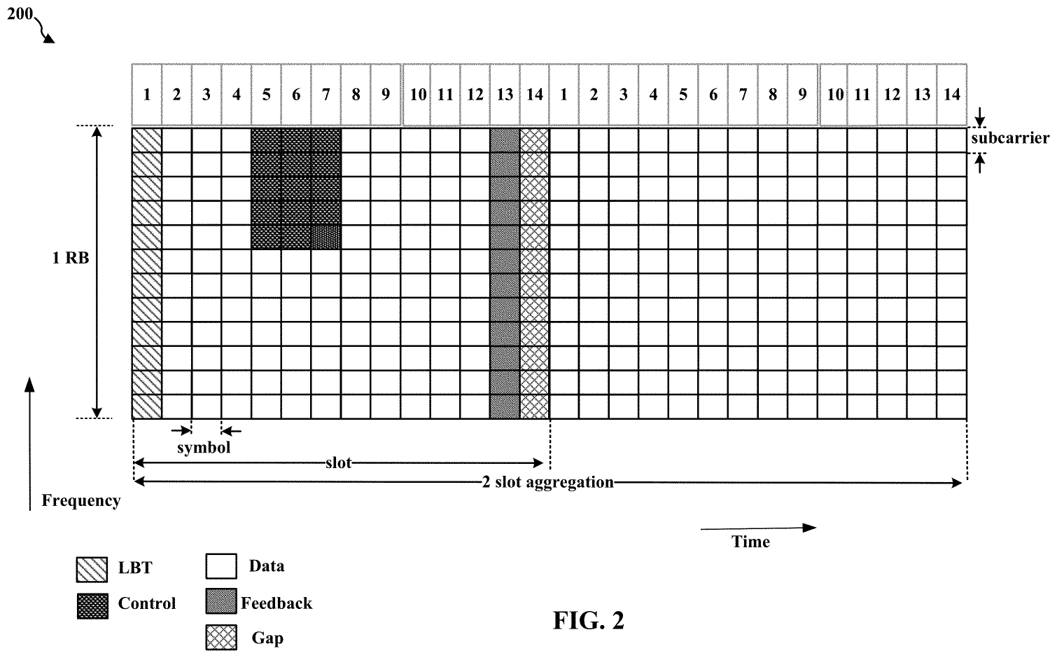

Some wireless communication networks may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian, and/or a combination thereof and/or with other devices, cellular vehicle-to-everything (C-V2X), which can be collectively referred to as vehicle-to-anything (V2X) communications. Referring again to FIG. 1, in certain aspects, a UE 104, e.g., a transmitting Vehicle User Equipment (VUE) or other UE, may be configured to transmit messages directly to another UE 104. The communication may be based on V2X or other D2D communication, such as Proximity Services (ProSe), etc. Communication based on V2X and/or D2D may also be transmitted and received by other transmitting and receiving devices, such as Road Side Unit (RSU) 107, etc. Aspects of the communication may be based on PC5 or sidelink communication e.g., as described in connection with the example in FIG. 2.

Referring again to FIG. 1, in certain aspects, a UE 104 may comprise a lower layer filter component 198 configured to filter V2X wireless communication at a lower OSI layer. Although not illustrated, RSU 107 or a base station may comprise a similar lower layer filter component for V2X communication. The UE may receive messages comprising a control channel and a data channel from other UEs. The lower layer filter component 198 may be configured to decode, at the physical layer, a subset of fields of the control channel. The lower layer filter component 198 may determine a priority of the message relative to the first UE based on the subset of fields and determines, at the physical layer, whether to decode the message based on the priority of the message relative to the first UE. The lower layer filter component 198 may forward the message to higher OSI layers for a next stage of decoding when a determination is made at the physical layer to decode the message. The UE may skip the next stage of decoding of the message at the higher OSI layers when the determination is made at the physical layer not to decode the message.

FIG. 2 is a diagram 200 illustrating an example of a slot structure that may be used within a 5G/NR frame structure, e.g., for sidelink communication. This is merely one example, and other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may comprise control information, e.g., along with demodulation RS (DM-RS). The control information may comprise Sidelink Control Information (SCI). At least one symbol at the beginning of a slot may be used by a transmitting device to perform a Listen Before Talk (LBT) operation prior to transmitting. At least one symbol may be used for feedback, as described herein. Another symbol, e.g., at the end of the slot may be used as a gap. The gap enables a device to switch from operating as a transmitting device to prepare to operate as a receiving device, e.g., in the following slot. Data may be transmitted in the remaining REs, as illustrated. The data may comprise the data message described herein. The position of any of the SCI, feedback, and LBT symbols may be different than the example illustrated in FIG. 2. Multiple slots may be aggregated together. FIG. 2 illustrates an example aggregation of two slot. The aggregated number of slots may also be larger than two. When slots are aggregated, the symbols used for feedback and/or a gap symbol may be different that for a single slot.

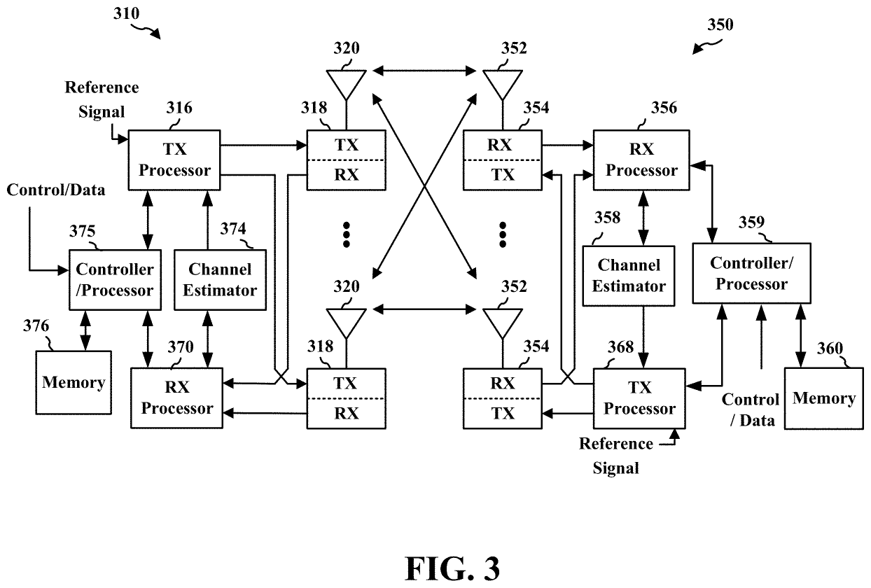

FIG. 3 is a block diagram of a first wireless communication device 310 in communication with a second wireless communication device 350, e.g., via V2X or other D2D communication. The device 310 and the device 350 may communicate based on sidelink. The transmitting device 310 may comprise a UE, an RSU, etc. The receiving device may comprise a UE, an RSU, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, or the controller/processor 359 of device 350 or the TX 316, the RX processor 370, or the controller/processor 375 may be configured to perform aspects described in connection with 198 of FIG. 1.

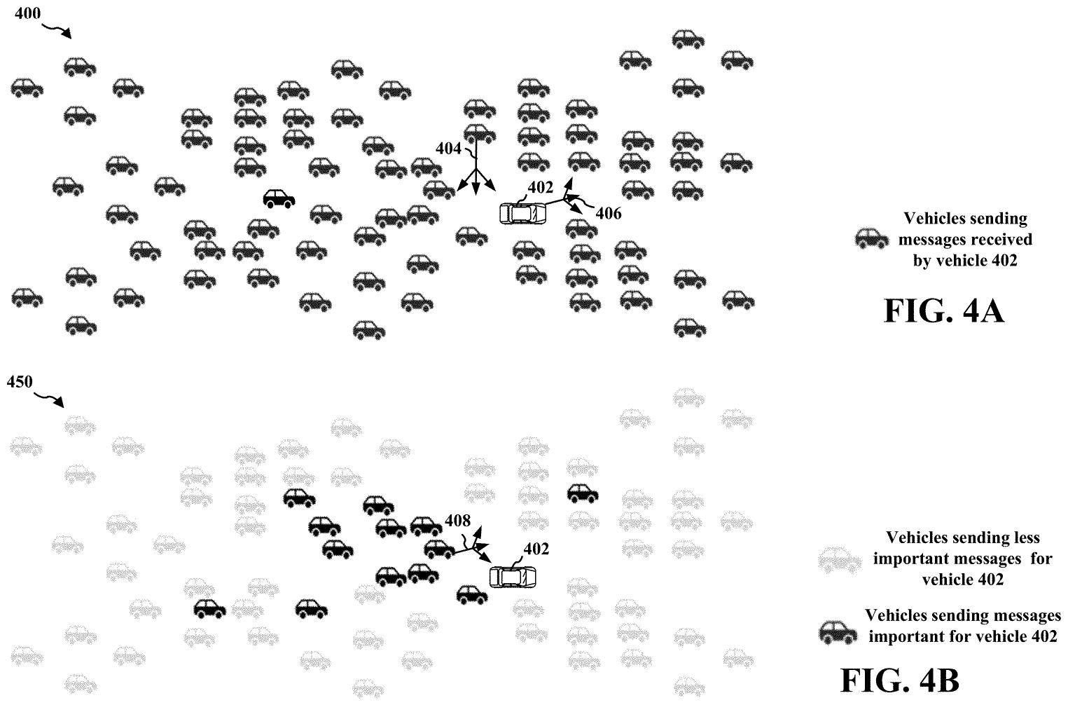

FIGS. 4A and 4B illustrate examples 400 of wireless communication between devices based on V2X/V2V/D2D communication. A receiving device, e.g., UE 402, receives transmissions, e.g., 404, 408, directly from transmitting devices, e.g., other vehicles. The received transmission 404, 408, may comprise a control channel and/or a corresponding data channel. In addition to operating as a receiving device, UE 402 may also operate as a transmitting device that transmits V2X/V2V/D2D communication 406. The transmissions 404, 406, 408 may be broadcast or multicast to nearby devices. The transmissions 404, 406, 408 may also be unicast, in some examples. Although not illustrated in FIGS. 4A and 4B, a receiving device may also receive communication from or transmit communication to an RSU, base station, infrastructure device, pedestrian device, or other device based on V2X/V2V/D2D communication, as illustrated in FIG. 1.

A control channel may include information for decoding a data channel and may also be used by receiving device to avoid interference by refraining from transmitting on the occupied resources during a data transmission. The number of TTIs, as well as the RBs that will be occupied by the data transmission, may be indicated in a control message from the transmitting device. The control channel may comprise any of a ProSe Per Packet-Priority (PPPP), a resource reservation, a resource indication value (RIV) with a one-to-one mapping of a start of a subchannel of retransmitted TBs and a number of sub-channels, a time gap between an initial transmission and a retransmission, a modulation and coding scheme (MCS), a retransmission index, reserved bits, a CRC, a Sender's identifier (ID), a sender's zone (e.g., low resolution indication of location of the sender), etc.

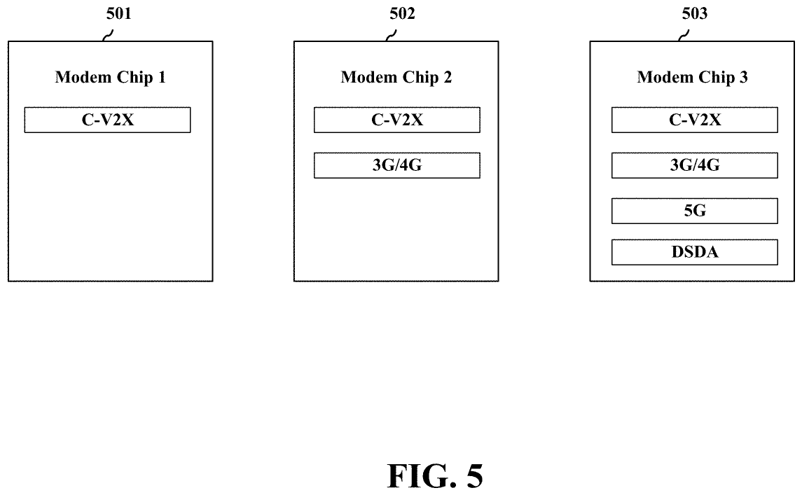

As illustrated in FIG. 5, modem chips may integrate various communication technologies within a single chip. Modem Chip 501 operates using C-V2X Radio Access Technology (RAT). Modem Chips 502, 503 are capable of operating using multiple RATs. As an example, Modem Chip 502 supports C-V2X and 3G/4G. Modem Chip 503 supports C-V2X, 3G/4G, 5G, and Dual Sim Dual Active (DSDA) operation. A modem chip that supports multiple RATs may operate using multiple RATs in a concurrent manner.

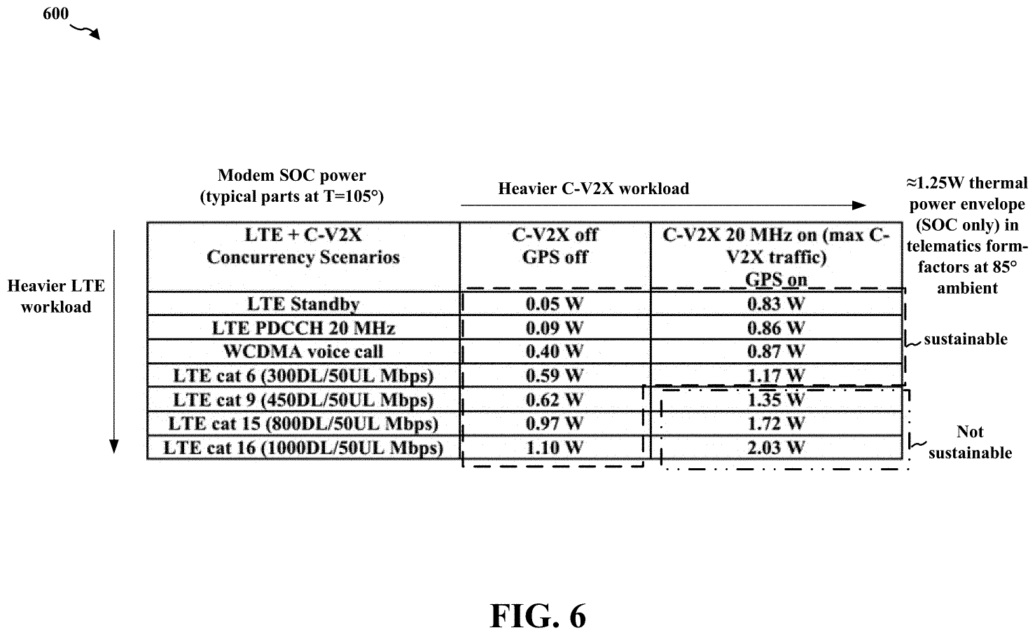

While a modem may support multiple RATs, there may be limitations on the modem's capability. For example, the modem may be limited by a performance budget, e.g., that limits a peak operating frequency of the modem. Such limitations may be based on a utilization percentage and clock cycle in a vector processing unit and/or a digital signal processor (DSP) limitation in mega packet per second (MPPS). As another example, the modem may be limited by a thermal power budget. The mobile chip package may place thermal limitations on operation. The modem may have a thin form and may be placed on the roof of a vehicle. As well, the modem may have a fan-less design that may place thermal limits on modem operation. As another example, the modem may be limited based on a power limitation, e.g., a peak current limitation. FIG. 6 illustrates an example 600 showing that concurrent operation using multiple RATs may not be sustainable at certain workloads. The first column illustrates an example of increasing workload for LTE operation. The workload from LTE standby to LTE PDCCH and then to operation for a wideband CDMA (WCDMA) voice call. Then, the LTE workload increases to an LTE category 6 operation that may include 300 Mbps of DL communication and/or 50 Mbps of UL communication. LTE category 9 communication may include 450 Mbps of DL communication and/or 50 Mbps of UL communication. LTE category 15 communication may include 800 Mbps of DL communication and/or 50 Mbps of UL communication. LTE category 16 communication may include 1000 Mbps of DL communication and/or 50 Mbps of UL communication. The second column illustrates power usage for a model that supports LTE and C-V2X concurrency scenarios according to the different LTE workloads when C-V2X and GPS are off. The third column shows power usage for the indicated LTE and C-V2X concurrency scenarios according to the indicated workloads when C-V2X and GPS are on. As illustrated, certain combined workloads may require power beyond an example 1.25 W limit. For example, LTE category 15 operation or LTE category 16 operation concurrently with C-V2X and GPS.

As illustrated in FIG. 4A, a UE 402 at a particular vehicle may receive messages from surrounding UEs. In dense population areas, may lead to the UE 402 receiving messages from a large amount of vehicles. For example, 20 transport blocks (TBs) per a 1 msecond (ms) subframe for a 20 MHz bandwidth configuration may enable UE 402 to receive approximately 20,000 incoming messages per second. However, as illustrated in the example 450 of FIG. 4B, a fraction of the incoming messages may be relevant for the UE 402. A receiving UE 402 in a particular vehicle may be referred to as a host vehicle. Other vehicles, with which the host vehicle communicates, may be referred to as remote vehicles. For example, a small number of incoming packets may result in a warning message or other action for the vehicle or driver. As an example, safety applications at a host vehicle may use data from basic safety messages (BSMs) of remote vehicles or RSUs to predict a potential crash and to alert the driver. Security processing, e.g., elliptic curve digital signature algorithm (ECDSA) may be able to be performed for 1,500 to 2,000 messages per second. This is a much lower number than the 20,000 messages per second that may be received. Furthermore, a driver may be able to practically handle a limited number of warnings, such as one warning message every few seconds. Furthermore, a UE that processes all received messages may place an unsustainable load on the performance capability, thermal capability, and/or power capability of a modem.

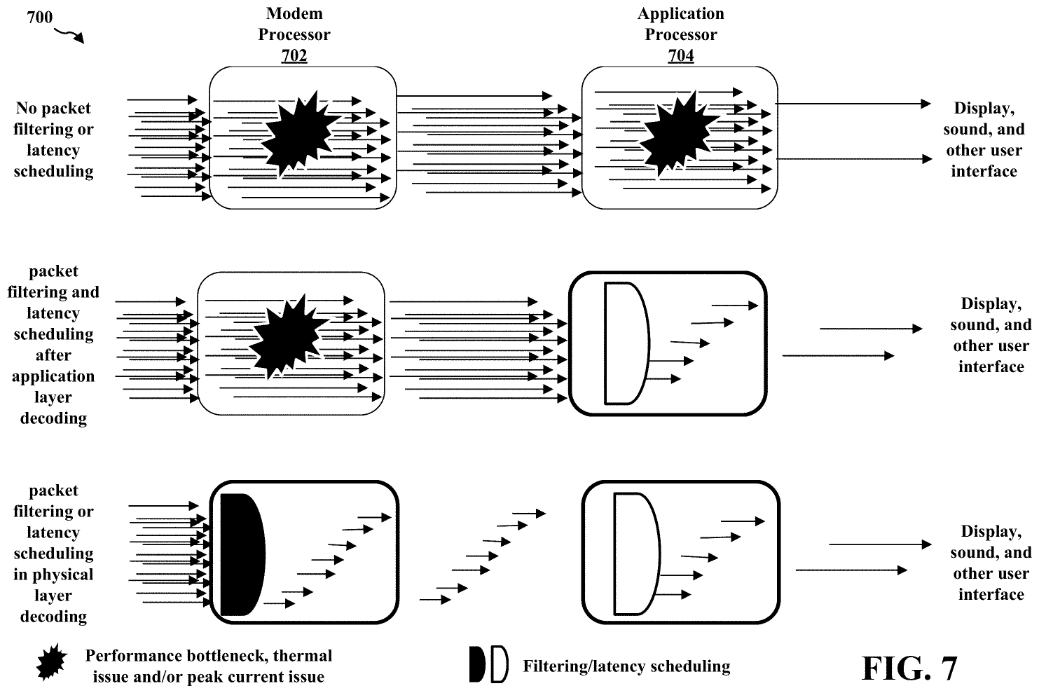

FIG. 7 illustrates an example comparison 700 of processing messages with and without filtering at different processing layers. The host vehicle's modem processor 702 provides decoding of V2X packets for lower Open Systems Interconnection (OSI) model layers, e.g., a physical layer, a data link layer, a network layer, and a transport layer. The host vehicle's application processor 704 provides decoding of the V2X packets for an intelligent transportation system (ITS) stack, e.g., for higher OSI layers such as a session layer, a presentation layer, and an application layer. The application processor 704 may also provide processing for ECDSA verification and OEM/customer application software.

In the top example, the host vehicle's modem processor 702 and application processor 704 receive and decode incoming packets from remote vehicles without packet filtering or latency scheduling. After processing by the modem processor and the application processor, the packets are used for display, sound, and other user interface information. As illustrated, processing all incoming packets from other vehicles may lead to performance issues, thermal issues and/or peak current issues at the modem processor 702 as well as the application processor 704.

In the middle example, the host vehicle's modem processor 702 receives and decodes incoming packets from remote vehicles without packet filtering or latency scheduling, and the application processor 704 filters/schedules the packets after application layer decoding. The application layer decoding enables the processor to determine the content of the message and to determine whether to continue to process the message. This may reduce some of the workload of the application processor 704 and may reduce some of the display, sound, and other user interface content. However, filtering/scheduling at the application processor may still lead to performance issues, thermal issues and/or peak current issues at the modem processor 702.

In the bottom example, packet filtering and/or latency scheduling may be performed at the modem processor, e.g., as part of a physical layer decoding of incoming packets. As illustrated in FIG. 7, by filtering messages at the physical layer, processing can be reduced at both the application processor 704 and the modem processor 702. This can also reduce the display, sound, and other user interface content. Thus, filtering/scheduling at the physical layer may help to avoid performance, thermal, and/or peak current issues at modem processor 702 and the application processor 704.

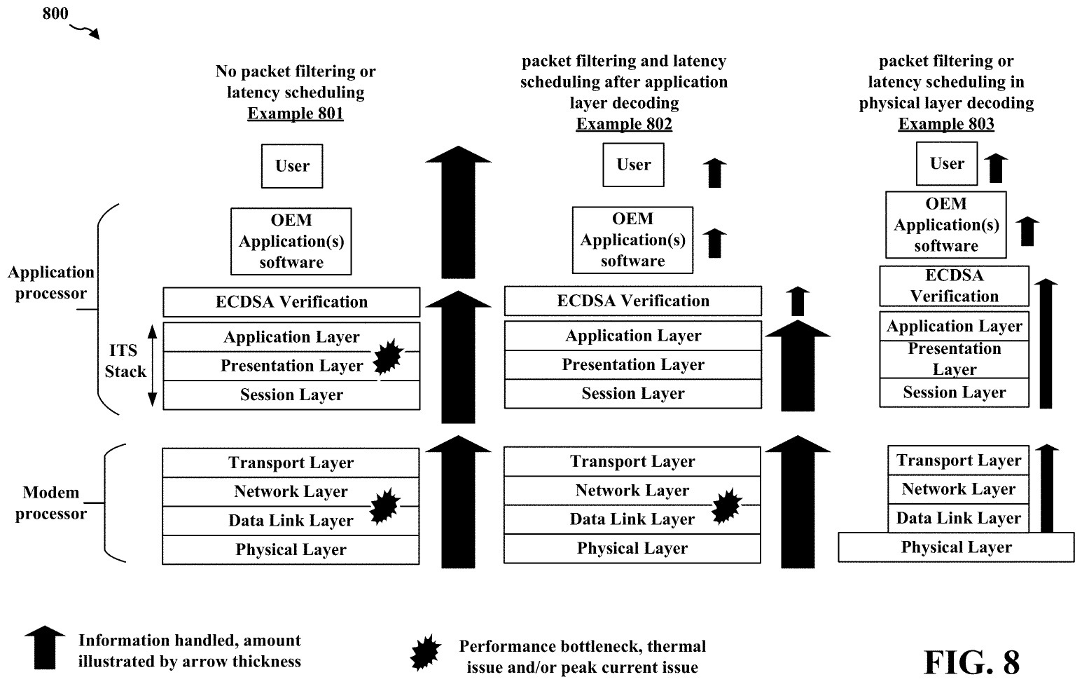

FIG. 8 illustrates an example comparison 800 of amounts of processing at the OSI layers for a host vehicle for different types of filtering/latency scheduling corresponding to the examples described in connection with FIG. 7. The OSI model partitions a communication system into abstraction layers. A layer serves the layer above it and is served by the layer below it. The function of the physical layer is the transmission and reception of raw bit streams over a physical medium. The data link layer functions may include multiplexing protocols on transmitting and demultiplexing on receiving, frame delimiting and recognition, handling address space, transparent data transfer of logical link control (LLC) protocol data units (PDUs), CRC checking, or control of access to the physical transmission medium. The network layer functions may include establishing, maintaining, and terminating network connections. The transport layer functions may include providing transparent transfer of data between session entities. The session layer functions may include supporting orderly data exchange by providing services to establish and release session connections between two presentation entities. The presentation layer functions may include providing for the representation of information that application entities refer to in their communication. The application layer functions may include providing means for application processes to access the wireless network. The lower layers may include the physical layer, the data link layer, the network layer, and the transport layer. Higher layers may refer to session layer, the presentation layer, and the application layer. Higher layers may also refer to ECDSA verification.

FIG. 8 illustrates the lower layers of the modem processor, e.g., the physical layer, data link layer, network layer, and transport layer. FIG. 8 also illustrates the higher layers of the application processor, e.g. the session layer, presentation layer, application layer, ECDSA verification, and OEM/application(s) software. Messages received by a host vehicle are processed by the lower layers followed by the higher layers before being provided to the application(s) and the user. The arrows in FIG. 8 illustrate the processing of incoming packets at the OSI layers of a host vehicle. The width of the arrows illustrates an amount of packets being processed.

In example 801, the host vehicle's modem processor and application processor receive and decode incoming packets from remote vehicles without packet filtering or latency scheduling. Thus, the constant arrow width shows that whatever packets are received by the host vehicle are decoded. As illustrated, processing all incoming packets from other vehicles may lead to performance issues, thermal issues and/or peak current issues at the modem processor as well as the application processor.

In example 802, the host vehicle's modem processor and application processor receives and decodes incoming packets from remote vehicles without packet filtering or latency scheduling, and the application processor filters/schedules the packets after application layer decoding. Thus, the arrow width is reduced following processing by the application layer. This may reduce some of the workload of the ECDSA verification and may reduce some of the display, sound, and other user interface content. However, filtering/scheduling at the application processor may still lead to performance issues, thermal issues and/or peak current issues at the modem processor and/or the session layer or presentation layer.

In example 803, packet filtering and/or latency scheduling may be performed at the physical layer as a part of decoding of incoming packets. Thus, in FIG. 8, the arrow width is reduced for the data link layer, network layer, transport layer, session layer, presentation layer, application layer, and so forth. Thus, filtering/scheduling at the physical layer may help to avoid performance, thermal, and/or peak current issues at modem processor and the application processor.

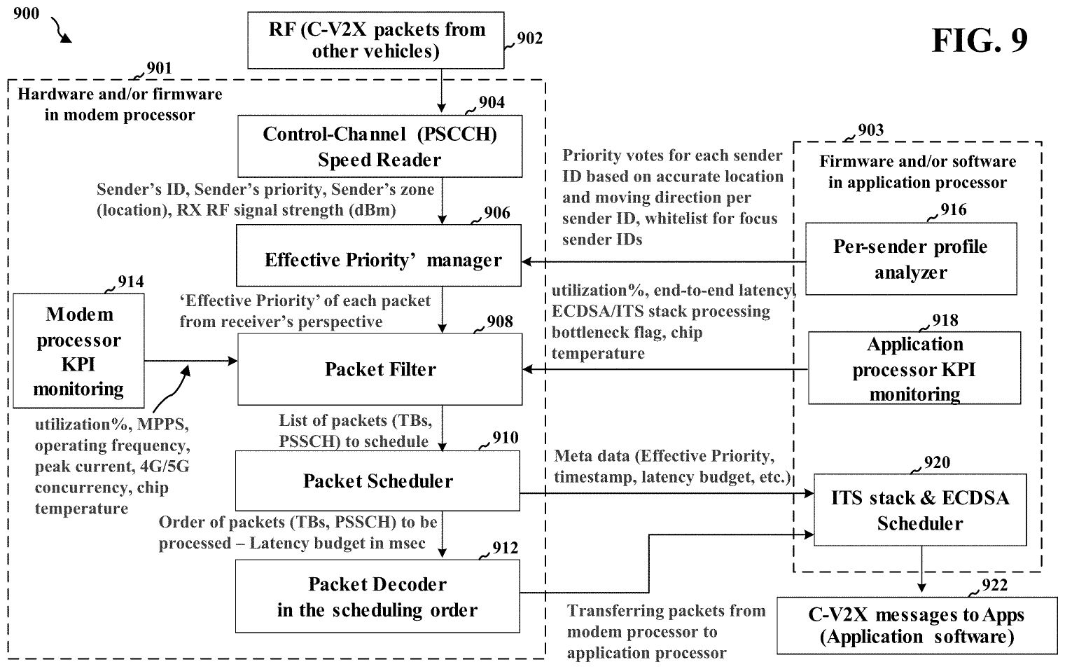

FIG. 9 illustrates an example diagram 900 of modem processor components and application processor components that may perform functions in processing received V2X packets. As illustrated at 902, V2X packets may be received from other vehicles by a wireless receiver. As illustrated at 904, a control channel component (which may be referred to as a control channel speed reader) comprised in a modem processor 901 may decode (or read) a subset of fields in the control channel of an incoming message. The control channel component 904 may decode the subset of fields for determining an effective priority of the message relative to the receiving device (e.g., the effective priority for the host vehicle). As an example, the control channel component 904 may decode a sender's ID, a sender's priority level (e.g., PPPP), or a sender's zone (e.g., a less accurate indication of the sender's location). The control channel component 904 may determine a received signal strength for the control channel, e.g., in dBm. Table 1 illustrates example fields that may be included in the control channel. Table 1 illustrates that without filtering, each of the fields is decoded at the physical layer. In contrast, the control channel component 904 may initially limit the decoding to a subset of fields.

TABLE 1

| | Without | With |
|---|---|---|
| | physical | physical |
| Fields in Control- | layer | layer |
| Channel (PSCCH) | filtering | filtering |
| Priority (PPPP - ProSe | Read | Read |
| Per-Packet Priority) | | |
| Resource reservation (RSVP) | Read | Defer |
| | | (read later) |
| RIV (resource indication | Read | Defer |
| value): 1-to-1 mapping of | | (read later) |
| start of subchannel of | | |
| retransmitted TB and number | | |
| of sub-channels | | |
| Time gap between initial | Read | Defer |
| Transmission and | | (read later) |
| Retransmission (SFgap) | | |
| Modulation and coding scheme | Read | Defer |
| | | (read later) |
| Retransmission index | Read | Defer |
| | | (read later) |
| Reserved bits | Read | Defer |
| | | (read later) |
| CRC | Read | Defer |
| | | (read later) |
| Sender's ID | Read | Read |
| Sender's zone (low | Read | Read |
| resolution location) | | |
| others | Read | Defer |
| | | (read later) |

As illustrated at 906, an effective priority manager may use the information from the subset of fields decoded by the control channel component 904 to determine an effective priority of each received packet. The effective priority is different than a PPPP, which is defined by the sender. Instead, the effective priority is a priority relative to the receiving device, e.g., the host vehicle. The effective priority indicates an actual criticality or relevance level to the host vehicle's current driving situation. The effective priority may be based on any of the sender's ID, the sender's priority level (e.g., PPPP), the sender's zone or the received signal strength for the packet. The effective priority may be further based on information received from an application processor. For example, a per-sender profile analyzer 916 at an application processor 903 may use prior messages from a sender to indicate priority votes for each sender ID. The priority votes may be based on more accurate location information for the sender (i.e., more accurate than the sender zone information), a moving direction of the sender, a whitelist for focus sender IDs, etc. The effective priority manager 906 may use the priority vote information in connection with the subset of fields decoded for a packet to determine the effective priority of the packet relative to the receiving device. For example, a sender that is closer to the host vehicle may receive a higher effective priority level. A sender that is moving in a direction toward the host vehicle may receive a higher effective priority level than a packet from a vehicle that is moving away from the host vehicle, and so forth.

As illustrated at 908, a packet filter may determine whether to continue decoding the packet or whether to skip decoding. For example, the packet filter 908 may filter out a portion of packets for which the partially decoded control channel is determined to have an effective priority that is lower than a threshold. These PSCCH blocks that are below the threshold may not be decoded, e.g., may be skipped. The threshold may be a predefined threshold. In another example, the threshold may be dynamic. For example, the threshold may be based on performance, power, and/or thermal status of the modem processor and/or the application processor. Thus, the packet filter 908 may receive status information for the modem processor 901 from modem processor key performance indicator (KPI) monitoring component 914. The status information for the modem processor 901 may include any of utilization percentage information, MPPS, operating frequency, peak current, multiple RAT concurrency, chip temperature, etc. Similarly, the packet filter 908 may receive status information from an application processor KPI monitoring component 918. The status information for the application processor 903 may include any of utilization percentage information, end-to-end latency information, ECDSA/ITS stack processing bottleneck indication (e.g., a flag to indicate a processing issue), chip temperature, etc. The packet filter 908 may use the information received from components 914 and/or 918 to determine a threshold to apply when filtering received packets. Thus, if another RAT is currently using the modem processor, e.g., streaming a video, a higher threshold may be applied in order to reduce the amount of V2X packets that are processed by the modem processor and application processor. If the other RATs supported by a modem chip have a light workload, a lower threshold may be applied so that more V2X packets are processed by the modem processor 901 and application processor 903.

An example threshold, e.g., N_{threshold} may be associated with a maximum number of packets to be processed. Packets having a lower effective priority than N_{threshold} may be filtered out, e.g., skipped without further decoding. N_{threshold} may be a minimum of N_{modem performance}, N_{modem power}, N_{modem thermal}, N_{application performance}, N_{application power}, and N_{application thermal}). N_{modem performance} may correspond to a maximum number of packets that can be processed in the modem from the performance perspective, e.g., a utilization percentage, an operating frequency, a remaining capability after processor for another RAT, etc. N_{modem power} may correspond to a maximum number of packets that can be processed in the modem from the peak power perspective, e.g., based on a power supply or power management integrated circuit (PMIC) capability. N_{modem thermal} may correspond to a maximum number of packets that can be processed in the modem from the peak power perspective, e.g., a system on a chip (SOC) temperature sustainable without thermal mitigation. N_{application performance} may correspond to a maximum number of packets that can be processed in the application processor from the from the performance perspective, e.g., a utilization percentage, an operating frequency, a remaining capability after other processing, etc. N_{application power} may correspond to a maximum number of packets that can be processed in the application processor from the peak power perspective, e.g., based on a power supply or power management integrated circuit (PMIC) capability. N_{application thermal} may correspond to a maximum number of packets that can be processed in the application processor from the peak power perspective, e.g., a system on a chip (SOC) temperature sustainable without thermal mitigation

Once the packet filter 908 determines that a packet is to be decoded, e.g., has a higher effective priority than the threshold, the additional fields of the control channel may be decoded, and the packet may be forwarded to the application processor for the next state of decoding. As an optional aspect, the modem processor may determine a decoding order for the packets that will be decoded. As illustrated at 910, a packet scheduler may receive an indication of the packets that pass the filter and will be decoded. The packet filter may determine a latency budget (e.g., in milliseconds) of each packet to be decoded and may determine an order for processing the packets based on the effective priority and/or the latency budget. The packet scheduler 910 may provide the order information as meta data provided to the application processor 903. For example, the packet scheduler may provide an effective priority, a timestamp, a latency budget, etc. to ITS stack and ECDSA scheduler 920. The packet scheduler 910 may indicate an order of packets, e.g.. TBs, PSSCH, to be processed to a packet decoder 912 that decodes the packets in the scheduling order. The packet decoder 912 may then transfer the packets from the modem processor to the application processor, e.g., to ITS stack and ECDSA scheduler 920 for next stage decoding. The decoded packets may then be provided to application software component(s) 922.

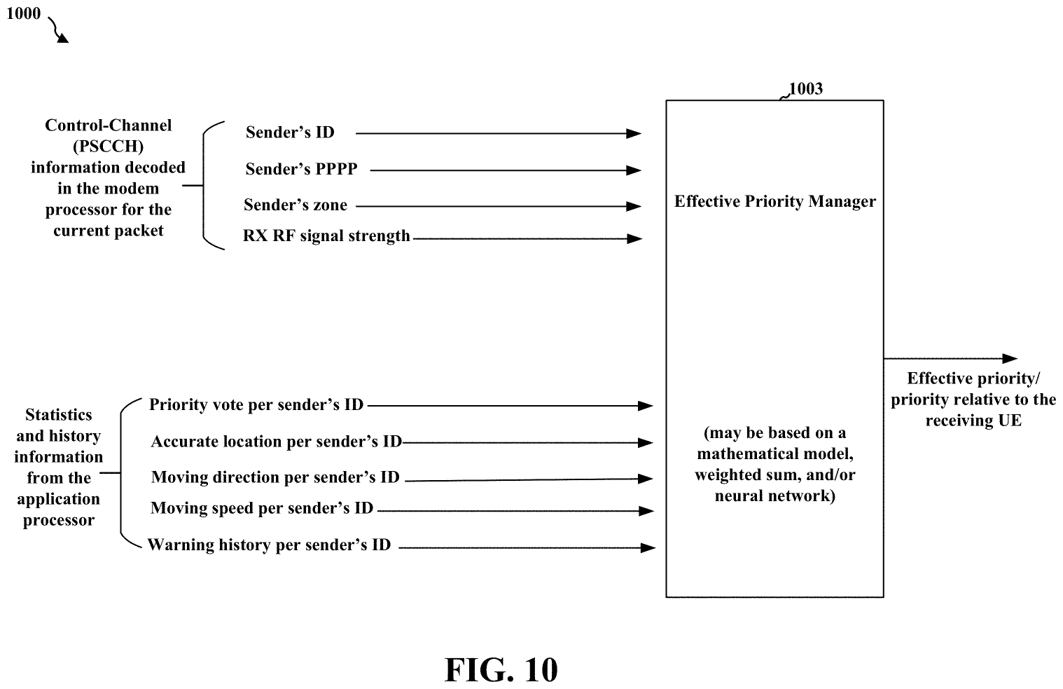

FIG. 10 illustrates an example 1000 of information received by an effective priority manager 1003, e.g., similar to 906 in FIG. 9. The effective priority manager 1003 may use information from the control channel of received packets. The effective priority manager 1003 may use priority vote information from the application processor. The effective priority manager determines a priority level from the perspective of the receiving device, e.g., a host vehicle receiving the packets. As illustrated in FIG. 8, the effective priority manager 1003 may use information from the PSCCH of a received packet, e.g., as processed by control channel component 904. Such information may comprise any of a sender's ID, a sender's priority (e.g., PPPP), a sender's zone, or a received signal strength. The effective priority manager 1003 may also use statistics and history information received from an application processor, which is based on previously received packets. Such information from the application processor may include any of a priority vote for a sender ID, an accurate location for a particular sender ID, a moving direction for a sender ID, a moving speed for a sender ID, or a warning history for a sender ID. Additionally and/or alternatively, the effective priority or filtering may be based on a signal-to-noise ratio (SNR) for the received packet, a modulation and coding scheme for the received packet, and/or an overlapping allocation for the packet. An allocation overlap may occur when more than one message overlap in the a frequency sub-band during a period of time, e.g., within a same subframe. The effective priority manager 1003 may determine the effective priority for incoming packets based on a mathematical model. The effective priority manager 1003 may determine the effective priority for incoming packets based on a weighted sum of different factors for the packet. The effective priority manager 1003 may determine the effective priority for incoming packets based on a neural network.

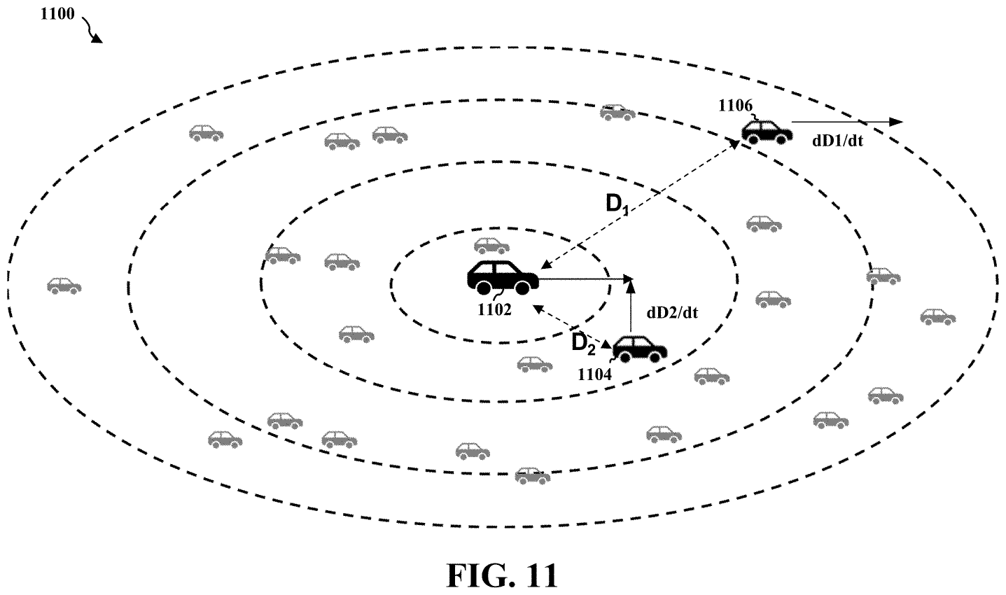

FIG. 11 illustrates an example 1100 of aspects that may be determined by in connection with determining a latency budget of received packets. As discussed in connection with packet scheduler 910 in FIG. 9, an order may be determined for packet processing. The order for processing may be based on the effective priority. The order for processing may be based on an effective priority and a distance between the host vehicle and the sending vehicle. The order for processing may be based on an effective priority, a distance between the host vehicle and the sending vehicle, and a speed of the host vehicle and/or the sending vehicle. The order for processing may be based on the distance between the host vehicle and the sending vehicle and/or a speed of the host vehicle and/or the sending vehicle. The order may be based on a direction of travel of the host vehicle and/or the sending vehicle. For example, a packet from a sender that is at a farther distance from the host vehicle 1102 can have a larger latency budget (e.g., in mseconds) because it may take longer for the sender vehicle to physically approach the host vehicle. A packet from a sender at a shorter distance may have a smaller latency budget because it may physically approach the host vehicle in a shorter amount of time. Thus, it may be more important to decode the message from the closer vehicle more quickly than a message from a more distant vehicle. Similarly, direction and speed may be a factor in determining a latency budget for a message, so that a message from a vehicle heading away from the host vehicle may have a larger latency budget than a vehicle headed toward the host vehicle.

A latency budget for a message received from another vehicle may be based on a distance between the host vehicle and the sending vehicle (D) and a distance change per unit time (dD/dt). For example, the latency budget (L) may be based on L=D/(dD/dt)*a scaling factor. D may be based on location information received from the sender. dD/dt may be based on direction and speed information for the sender vehicle and/or for the host vehicle. FIG. 11 illustrates a first sending vehicle 1106 at a distance D1 from host vehicle 1102 that receives a message from sending vehicle 1106. Vehicle 1106 is moving away from host vehicle 1102 at a rate of dD1/dt. A second sending vehicle 1104 is located at a distance D2 from host vehicle 1102 and is moving toward the path of the host vehicle 1102 at a rate of dD2/dt. A message from second sending vehicle 1104 may be determined to have a lower latency budget than a message received from first sending vehicle 1106 due to the shorter distance D2<D1 and/or based on the direction and speed of vehicle 1104 relative to vehicle 1106.

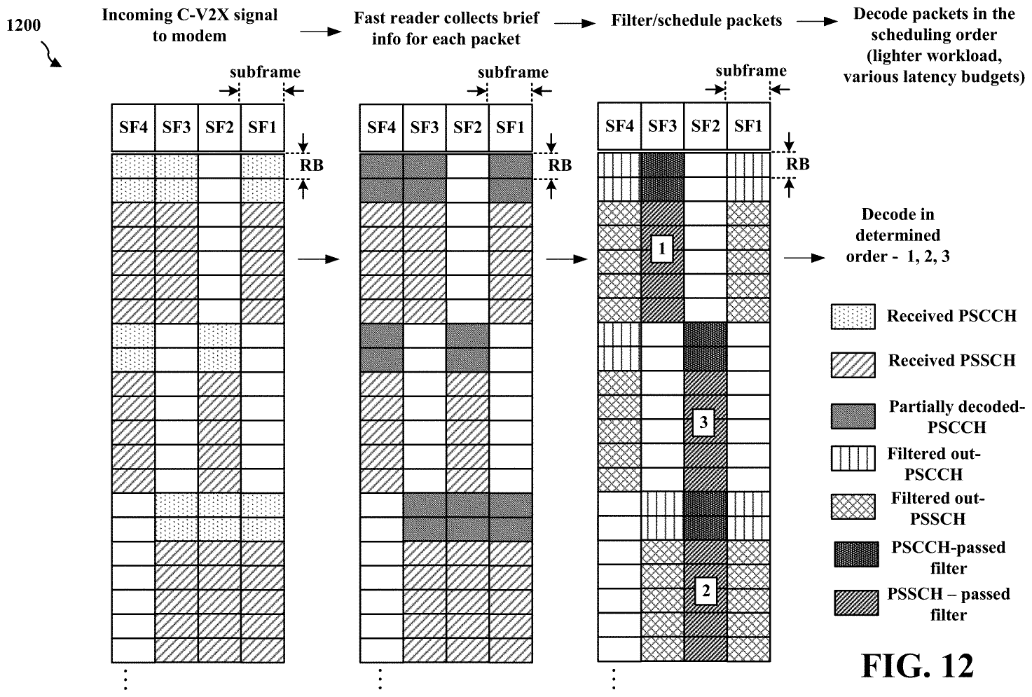

FIG. 12 illustrates an example 1200 of processing received messages based on V2X communication. As illustrated, each message comprises a control channel (PSCCH) and a data channel (PSSCH). The incoming V2X signals received by the modem are illustrated as a heavy workload, and the modem may have strict latency requirements for handling all received packets. After receipt, the PSCCH for each of the received packets is partially decoded. As described in connection with the control channel component 904 of FIG. 9, a subset of control channel fields may be decoded in order to determine an effective priority relative to the receiving device. Then, an effective priority algorithm may be used to prioritize the packets for filtering and scheduling. Three of the received packets are illustrated as passing the priority assessment of the filter. The remaining packets may have had an effective priority below a threshold and will not proceed to next stage decoding. The three packets that will be forwarded for next stage decoding are numbered with a determined order. The determined order has a packet numbered with “1” that was received in a later subframe (subframe 3) and is ordered to be decoded prior to packets (numbered “2” and “3”) that were received in an earlier subframe (subframe 2). The modem may decode the packets in the scheduling order. The filtering of the packets based on the partial decoding of the PSCCH lightens the workload of the modem processor so that the modem processor decodes three of the 8 received packets.

As the packet filtering at the physical layer reduces the workload in a modem processor for V2X communication, more processing resources may become available for other concurrent workloads based on different RATs (e.g., 4G, 5G, Audio, GPS, etc.) At the application processor, additional processing resources may become available for a customer's application software. The latency scheduling option based on the effective priority will allow the host vehicle to apply a longer latency to lower priority/less relevant packets. In the modem processor, this makes it possible for the modem and DSP to dynamically scale up/down the operating frequency without continually running at the maximum frequency. This may help the modem to be prepared for unexpected peak packet loading. In the application processor, the latency scheduling makes it possible for the application processor to dynamically scale up/down the operating frequency without continually running at the maximum frequency.

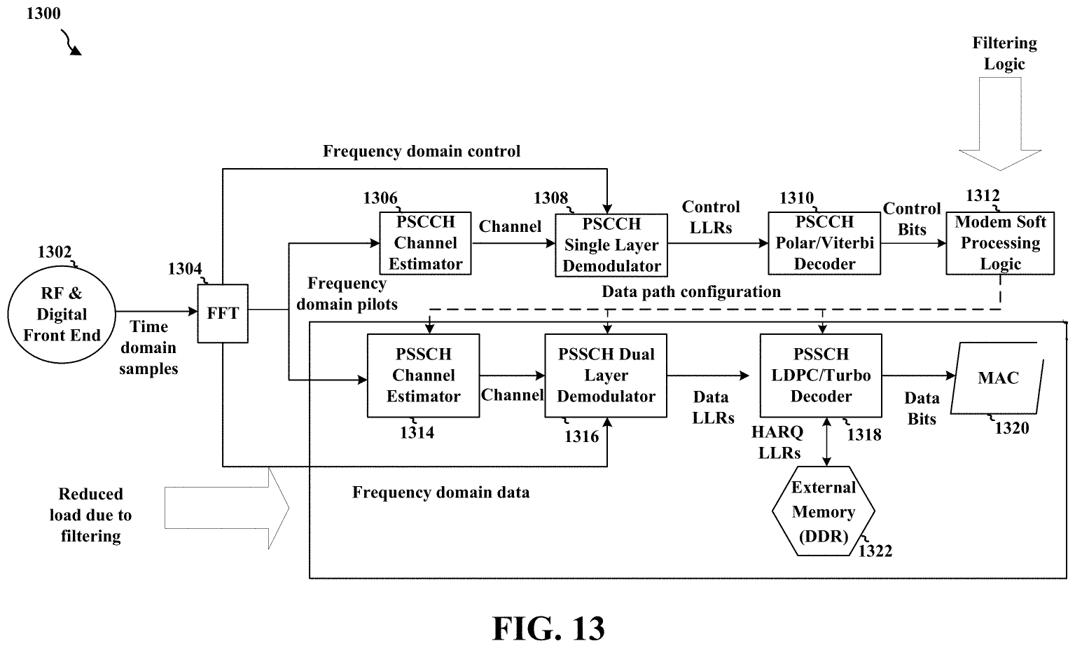

FIG. 13 illustrates an example diagram 1300 showing the portions of the processing that have a reduced load due to the physical layer filtering described herein. A V2X signal is received at an RF and digital front end 1302, and Fast Fourier Transform (FFT) 1304 is applied to the time domain samples. The frequency domain pilots for the PSCCH are processed by a PSCCH channel estimator 1306, a PSCCH single layer demodulator 1308, a PSCC decoder 1310, and control bits are provided for filtering by processing logic 1312. Filter packets are then forwarded for next stage decoding, e.g., decoding of the data channel. Thus, information may be provided to PSSCH channel estimator 1314 that begins the processing of the PSSCH for packets that pass the effective priority filter applied to the information from the PSCCH. The processed channel is then provided to the PSSCH dual layer demodulator 1316, the PSSCH decoder 1318, the MAC 1320 and/or external memory 1322. The workload of the PSSCH channel estimator 1314, the PSSCH dual layer demodulator 1316, the PSSCH decoder 1318, the MAC 1320 and/or external memory 1322 may be reduced based on the filtering at the physical layer by determining an effective priority of the received packet relative to the receiving vehicle and determining whether the effective priority is high enough to continue decoding the packet.

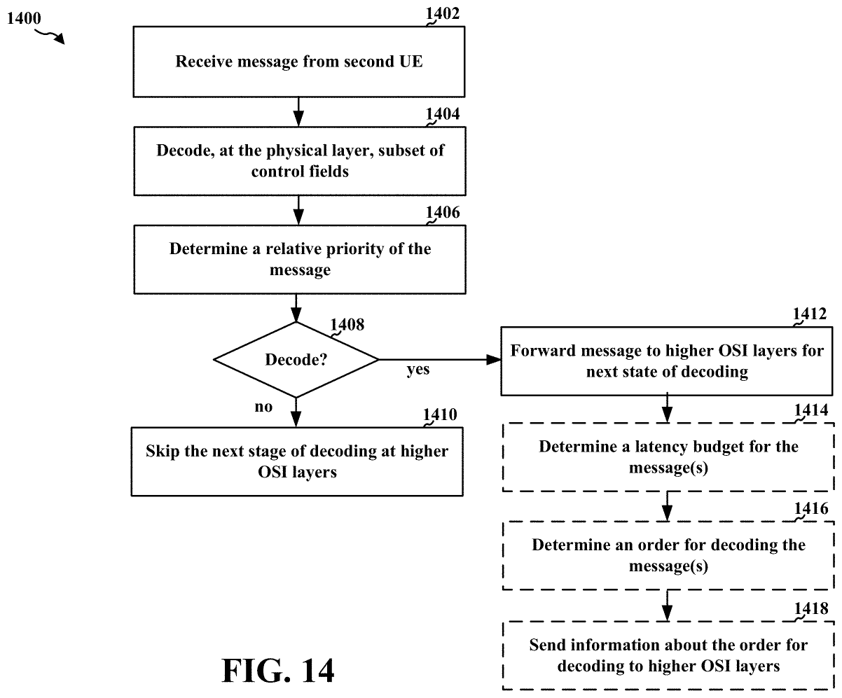

FIG. 14 is a flowchart 1400 of a method of wireless communication at a first UE. The communication may be based on V2X or other D2D communication. For example, the communication may be based on C-V2X communication. The method may be performed by a receiving device/receiving UE (e.g., UE 102, 402, 1102, device 310, 350, the apparatus 1502, or the communication manager 1532). The UE may be a host vehicle or a component of a host vehicle receiving a message from a sending vehicle or a remote vehicle. Optional aspects are illustrated with a dashed line. The method enables a UE to reduce a workload at higher layers by filtering and/or scheduling packets at lower layers. Thus, the method improves the efficiency with which the UE receives communication and enables the UE to avoid performance issues, thermal issues, and peak current issues.

At 1402, the first UE receives, at a physical layer, a message from a second UE, the message comprising a control channel and a data channel. Aspects regarding the receipt of a message are described in connection with FIGS. 3, 8, 9, 12, and 13. The receipt of the message may be performed, e.g., by message component 1540 in apparatus 1502.

At 1404, the first UE decodes, at the physical layer, a subset of fields comprised in the control channel. The subset of fields decoded from the control channel may comprise any of a PPPP for the message, an ID of the second UE, a zone of the second UE, or a signal strength of the message measured by the first UE, e.g., as described in connection with Table 1. The decoding of the subset of fields may be performed, e.g., by physical layer decode component 1542 in apparatus 1502.

At 1406, the first UE determines a priority of the message relative to the first UE based on the subset of fields decoded at the physical layer. The determination may be performed, e.g., by relative priority component 1544 in apparatus 1502. The priority of the message relative to the first UE may be further based on additional information from an application processor of the first UE, wherein the additional information comprises at least one of an accurate location of the second UE, a moving direction of the second UE, a speed of the second UE, or a list of IDs of UEs to be tracked from a higher level software application perspective, e.g., as described in connection with effective priority manager 906, 1003.

At 1408, the first UE determines, at the physical layer, whether to decode the message based on the priority of the message relative to the first UE. The determination may be performed, e.g., by filter component 1546 in apparatus 1502. The determination about whether to decode the message may be based on a comparison of a threshold to the priority of the message relative to the first UE. The threshold may comprise a predefined threshold. The threshold may comprise a dynamic threshold. The threshold may be based on operating information about a modem processor of the first UE. The operating information about the modem processor may comprise at least one of a modem performance parameter, a modem power parameter, or a modem thermal parameter. The operating information may comprise at least one of a percentage of utilization of the modem processor, a Mega Packet per Second (MPPS) of the modem processor, an operating frequency of the modem processor, a peak current of the modem processor, concurrent operation of the modem processor, or a temperature of the modem processor. The threshold may be based on operating information about an application processor of the first UE. The operating information about the application processor may comprise at least one of an application performance parameter, an application power parameter, or an application thermal parameter. The operating information may comprise at least one of a percentage of utilization of the application processor, a latency of the application processor, a processing flag for a stack of the application processor, or a temperature of the application processor.

At 1412, the first UE forwards the message to higher OSI layers for a next stage of decoding when a determination is made at the physical layer to decode the message. The forwarding may be performed, e.g., by forward component 1548. At 1410, the first UE skips the next stage of decoding of the message at the higher OSI layers when the determination is made at the physical layer not to decode the message.

The first UE may receive a plurality of messages and may determine, at the physical layer, to decode a subset of messages from the plurality of messages. The first UE may determine an order for decoding the subset of messages, at 1416. The determination may be performed, e.g., by order component 1552. Example aspects of the determination of an order is described in connection with packet scheduler 910 in FIG. 9.

The first UE may send information about the order for decoding the subset of messages to the higher OSI layers, at 1418. The information may be sent, e.g., by order information component 1554. For example, the first UE may send the information as meta data, as described in connection with packet scheduler 910 in FIG. 9.

As illustrated at 1414, the first UE may determine a latency budget for each of the subset of messages, wherein the order is determined based on the latency budget determined for each of the subset of messages. The latency budget may be determined, e.g., by latency component 1556. The determination of a latency budget is described in connection with FIG. 11. The latency budget for a respective message may be based, at least in part, on a distance between the first UE and a transmitting UE for the respective message. The latency budget for a respective message may be based on at least one of a first direction of travel of the first UE, a second direction of travel of a transmitting UE for the respective message, a first speed of the first UE, or a second speed of the transmitting UE for the respective message. The latency budget for a respective message may be based on a distance between the first UE and a transmitting UE for the respective message in combination with at least one of a first direction of travel of the first UE, a second direction of travel of the transmitting UE for the respective message, a first speed of the first UE, or a second speed of the transmitting UE for the respective message.

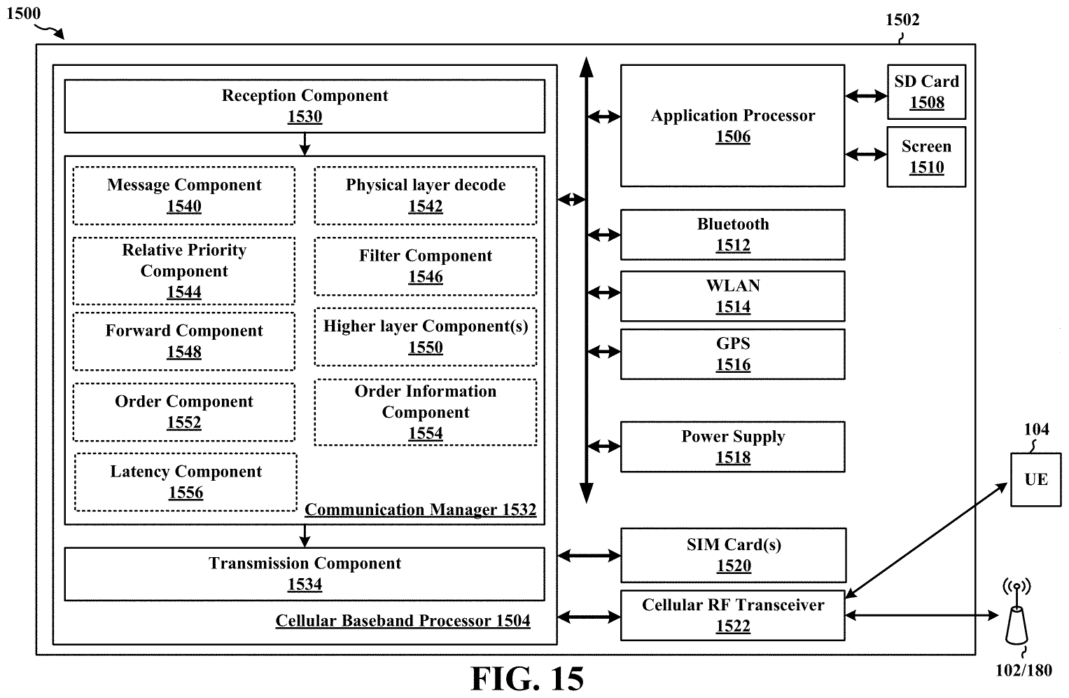

FIG. 15 is a diagram 1500 illustrating an example of a hardware implementation for an apparatus 1502. The apparatus 1502 may be a UE or a component of a UE and includes a cellular baseband processor 1504 (also referred to as a modem) coupled to a cellular RF transceiver 1522 and one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, and a power supply 1518. The cellular baseband processor 1504 communicates through the cellular RF transceiver 1522 with the UE 104 and/or BS 102/180. The cellular baseband processor 1504 may include a computer-readable medium/memory. The cellular baseband processor 1504 is responsible for general processing, including the execution of software stored on the computer-readable medium/memory. The software, when executed by the cellular baseband processor 1504, causes the cellular baseband processor 1504 to perform the various functions described supra. The computer-readable medium/memory may also be used for storing data that is manipulated by the cellular baseband processor 1504 when executing software. The cellular baseband processor 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the cellular baseband processor 1504. The cellular baseband processor 1504 may be a component of the device 350 and may include the memory 360 and/or at least one of the TX processor 368, the RX processor 356, and the controller/processor 359. In one configuration, the apparatus 1502 may be a modem chip and include just the baseband processor 1504, and in another configuration, the apparatus 1502 may be the entire UE (e.g., see the device 350 of FIG. 3) and include the additional modules of the apparatus 1502.

The apparatus includes a message component 1540 configured to receive, at a physical layer, a message from a second UE, the message comprising a control channel and a data channel. The apparatus includes a physical layer decode component 1542 configured to decode, at the physical layer, a subset of fields comprised in the control channel. The subset of fields may comprise any of a PPPP a ProSe per-packet priority (PPPP), an ID of the second UE, a zone of the second UE, or a signal strength of the message measured by the first UE. The apparatus includes a relative priority component 1544 configured to determine a priority of the message relative to the first UE based on the subset of fields decoded at the physical layer. The apparatus includes a filter component 1546 configured to determine, at the physical layer, whether to decode the message based on the priority of the message relative to the first UE. The determination about whether to decode the message may be based, e.g., on a comparison of a threshold to the priority of the message relative to the first UE. The apparatus includes a forward component 1548 configured to forward the message to higher OSI layers, e.g., higher layer component(s) 1550 for a next stage of decoding when a determination is made at the physical layer to decode the message. The apparatus may skip the next stage of decoding of the message at the higher OSI layers when the determination is made at the physical layer not to decode the message. The apparatus may include an order component 1552 configured to determine an order for decoding the subset of messages. The apparatus may include an order information component 1554 configured to send information about the order for decoding the subset of messages to the higher OSI layers. The apparatus may include a latency component 1556 configured to determine a latency budget for each of the subset of messages, wherein the order is determined based on the latency budget determined for each of the subset of messages.

The apparatus may include additional components that perform each of the blocks of the algorithm in the aforementioned flowchart of FIG. 14. As such, each block in the aforementioned flowchart of FIG. 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof

In one configuration, the apparatus 1502, and in particular the cellular baseband processor 1504, includes means for means for receiving, at a physical layer, a message from a second UE, the message comprising a control channel and a data channel. The apparatus includes means for decoding, at the physical layer, a subset of fields comprised in the control channel. The subset of fields may comprise any of a PPPP a ProSe per-packet priority (PPPP), an ID of the second UE, a zone of the second UE, or a signal strength of the message measured by the first UE. The apparatus includes means for determining a priority of the message relative to the first UE based on the subset of fields decoded at the physical layer. The apparatus includes means for determining, at the physical layer, whether to decode the message based on the priority of the message relative to the first UE. The determination about whether to decode the message may be based, e.g., on a comparison of a threshold to the priority of the message relative to the first UE. The apparatus includes means for forwarding the message to higher open system interconnection (OSI) layers for a next stage of decoding when a determination is made at the physical layer to decode the message. The apparatus may include means for skipping the next stage of decoding of the message at the higher OSI layers when the determination is made at the physical layer not to decode the message. The apparatus may include means for determining an order for decoding the subset of messages. The apparatus may include means for sending information about the order for decoding the subset of messages to the higher OSI layers. The apparatus may include means for determining a latency budget for each of the subset of messages, wherein the order is determined based on the latency budget determined for each of the subset of messages. The aforementioned means may be one or more of the aforementioned components of the apparatus 1502 configured to perform the functions recited by the aforementioned means. As described supra, the processing system may include the TX processor 316, 368, the RX processor 370, 356, and the controller/processor 375, 359. As such, in one configuration, the aforementioned means may be the TX processor 316, 368, the RX processor 370, 356, and the controller/processor 375, 359 configured to perform the functions recited by the aforementioned means.

The following examples are illustrative only and aspects thereof may be combined with aspects of other embodiments or teaching described herein, without limitation.

Example 1 is a method of C-V2X wireless communication at a first UE, comprising: receiving, at a physical layer, a message from a second UE, the message comprising a control channel and a data channel; decoding, at the physical layer, a subset of fields comprised in the control channel; determining a priority of the message relative to the first UE based on the subset of fields decoded at the physical layer; determining, at the physical layer, whether to decode the message based on the priority of the message relative to the first UE; and forwarding the message to higher OSI layers for a next stage of decoding when a determination is made at the physical layer to decode the message.

In Example 2, the method of Example 1 further includes skipping the next stage of decoding of the message at the higher OSI layers when the determination is made at the physical layer not to decode the message.

In Example 3, the method of Example 1 or Example 2 further includes that the subset of fields decoded from the control channel comprises a PPPP, an ID of the second UE, a zone of the second UE, or a signal strength of the message measured by the first UE.

In Example 4, the method of any of Examples 1-3 further include that the priority of the message relative to the first UE is further based on additional information from an application processor of the first UE, wherein the additional information comprises at least one of an accurate location of the second UE, a moving direction of the second UE, a speed of the second UE, or a list of IDs of UEs to be tracked from a higher level software application perspective.

In Example 5, the method of any of Examples 1-4 further include that the determination about whether to decode the message is based on a comparison of a threshold to the priority of the message relative to the first UE.

In Example 6, the method of any of Examples 1-5 further include that the threshold comprises a predefined threshold.

In Example 7, the method of any of Examples 1-6 further include that the threshold comprises a dynamic threshold.

In Example 8, the method of any of Examples 1-7 further include that the threshold is based on operating information about a modem processor of the first UE.

In Example 9, the method of any of Examples 1-8 further include that the operating information about the modem processor comprises at least one of a modem performance parameter, a modem power parameter, or a modem thermal parameter.

In Example 10, the method of any of Examples 1-9 further include that the operating information comprises at least one of a percentage of utilization of the modem processor, a Mega Packet per Second (MPPS) of the modem processor, an operating frequency of the modem processor, a peak current of the modem processor, concurrent operation of the modem processor, or a temperature of the modem processor.

In Example 11, the method of any of Examples 1-10 further include that the threshold is based on operating information about an application processor of the first UE.

In Example 12, the method of any of Examples 1-11 further include that the operating information about the application processor comprises at least one of an application performance parameter, an application power parameter, or an application thermal parameter.

In Example 13, the method of any of Examples 1-12 further include that the operating information comprises at least one of a percentage of utilization of the application processor, a latency of the application processor, a processing flag for a stack of the application processor, or a temperature of the application processor.

In Example 14, the method of any of Examples 1-13 further include that the first UE receives a plurality of messages and determines, at the physical layer, to decode a subset of messages from the plurality of messages, the method further comprising: determining an order for decoding the subset of messages; and sending information about the order for decoding the subset of messages to the higher OSI layers.

In Example 15, the method of any of Examples 1-14 further include determining a latency budget for each of the subset of messages, wherein the order is determined based on the latency budget determined for each of the subset of messages.

In Example 16, the method of any of Examples 1-15 further include that the latency budget for a respective message is based, at least in part, on a distance between the first UE and a transmitting UE for the respective message.

In Example 17, the method of any of Examples 1-16 further include that the latency budget for a respective message is based on at least one of a first direction of travel of the first UE, a second direction of travel of a transmitting UE for the respective message, a first speed of the first UE, or a second speed of the transmitting UE for the respective message.

In Example 18, the method of any of Examples 1-17 further include that the latency budget for a respective message is based on a distance between the first UE and a transmitting UE for the respective message in combination with at least one of a first direction of travel of the first UE, a second direction of travel of the transmitting UE for the respective message, a first speed of the first UE, or a second speed of the transmitting UE for the respective message.

Example 19 is a device including one or more processors and one or more memories in electronic communication with the one or more processors storing instructions executable by the one or more processors to cause the device to implement a method as in any of Examples 1-18.

Example 20 is a system or apparatus including means for implementing a method or realizing an apparatus as in any of Examples 1-18.

Example 21 is a non-transitory computer readable medium storing instructions executable by one or more processors to cause the one or more processors to implement a method as in any of Examples 1-18.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of cellular vehicle-to-everything (C-V2X) wireless communication at a first user equipment (UE), comprising:
receiving, at a physical layer, a message from a second UE, the message comprising a control channel and a data channel;
decoding, at the physical layer, a subset of fields comprised in the control channel;
determining a priority of the message relative to the first UE based on the subset of fields decoded at the physical layer;
determining, at the physical layer, whether to decode the message based on the priority of the message relative to the first UE; and
forwarding the message to higher open system interconnection (OSI) layers for a next stage of decoding when a determination is made at the physical layer to decode the message.

2. The method of claim 1, further comprising:
skipping the next stage of decoding of the message at the higher OSI layers when the determination is made at the physical layer not to decode the message.

3. The method of claim 1, wherein the subset of fields decoded from the control channel comprises a ProSe per-packet priority (PPPP), an identifier (ID) of the second UE, a zone of the second UE, or a signal strength of the message measured by the first UE.

4. The method of claim 3, wherein the priority of the message relative to the first UE is further based on additional information from an application processor of the first UE, wherein the additional information comprises at least one of an accurate location of the second UE, a moving direction of the second UE, a speed of the second UE, or a list of identifiers (IDs) of UEs to be tracked from a higher level software application perspective.

5. The method of claim 1, wherein the determination about whether to decode the message is based on a comparison of a threshold to the priority of the message relative to the first UE.

6. The method of claim 5, wherein the threshold comprises a predefined threshold.

7. The method of claim 5, wherein the threshold comprises a dynamic threshold.

8. The method of claim 7, wherein the threshold is based on operating information about a modem processor of the first UE.

9. The method of claim 8, wherein the operating information about the modem processor comprises at least one of a modem performance parameter, a modem power parameter, or a modem thermal parameter.

10. The method of claim 8, wherein the operating information comprises at least one of a percentage of utilization of the modem processor, a Mega Packet per Second (MPPS) of the modem processor, an operating frequency of the modem processor, a peak current of the modem processor, concurrent operation of the modem processor, or a temperature of the modem processor.

11. The method of claim 7, wherein the threshold is based on operating information about an application processor of the first UE.

12. The method of claim 11, wherein the operating information about the application processor comprises at least one of an application performance parameter, an application power parameter, or an application thermal parameter.

13. The method of claim 11, wherein the operating information comprises at least one of a percentage of utilization of the application processor, a latency of the application processor, a processing flag for a stack of the application processor, or a temperature of the application processor.

14. The method of claim 1, wherein the first UE receives a plurality of messages and determines, at the physical layer, to decode a subset of messages from the plurality of messages, the method further comprising:
determining an order for decoding the subset of messages; and
sending information about the order for decoding the subset of messages to the higher OSI layers.

15. The method of claim 14, further comprising:
determining a latency budget for each of the subset of messages, wherein the order is determined based on the latency budget determined for each of the subset of messages.

16. The method of claim 15, wherein the latency budget for a respective message is based, at least in part, on a distance between the first UE and a transmitting UE for the respective message.

17. The method of claim 15, wherein the latency budget for a respective message is based on at least one of a first direction of travel of the first UE, a second direction of travel of a transmitting UE for the respective message, a first speed of the first UE, or a second speed of the transmitting UE for the respective message.

18. The method of claim 15, wherein the latency budget for a respective message is based on a distance between the first UE and a transmitting UE for the respective message in combination with at least one of a first direction of travel of the first UE, a second direction of travel of the transmitting UE for the respective message, a first speed of the first UE, or a second speed of the transmitting UE for the respective message.

19. An apparatus for cellular vehicle-to-everything (C-V2X) wireless communication at a first user equipment (UE), comprising:
means for receiving, at a physical layer, a message from a second UE, the message comprising a control channel and a data channel;
means for decoding, at the physical layer, a subset of fields comprised in the control channel;
means for determining a priority of the message relative to the first UE based on the subset of fields decoded at the physical layer;
means for determining, at the physical layer, whether to decode the message based on the priority of the message relative to the first UE; and
means for forwarding the message to higher open system interconnection (OSI) layers for a next stage of decoding when a determination is made at the physical layer to decode the message.

20. An apparatus for cellular vehicle-to-everything (C-V2X) wireless communication at a first user equipment (UE), comprising:
a memory; and
at least one processor coupled to the memory and configured to:
receive, at a physical layer, a message from a second UE, the message comprising a control channel and a data channel;
decode, at the physical layer, a subset of fields comprised in the control channel;
determine a priority of the message relative to the first UE based on the subset of fields decoded at the physical layer;
determine, at the physical layer, whether to decode the message based on the priority of the message relative to the first UE; and
forward the message to higher open system interconnection (OSI) layers for a next stage of decoding when a determination is made at the physical layer to decode the message.

21. The apparatus of claim 20, wherein the at least one processor is further configured to:
skip the next stage of decoding of the message at the higher OSI layers when the determination is made at the physical layer not to decode the message.

22. The apparatus of claim 20, wherein the subset of fields decoded from the control channel comprises a ProSe per-packet priority (PPPP), an identifier (ID) of the second UE, a zone of the second UE, or a signal strength of the message measured by the first UE.

23. The apparatus of claim 22, wherein the priority of the message relative to the first UE is further based on additional information from an application processor of the first UE, wherein the additional information comprises at least one of an accurate location of the second UE, a moving direction of the second UE, a speed of the second UE, or a list of identifiers (IDs) of UEs to be tracked from a higher level software application perspective.

24. The apparatus of claim 20, wherein the determination about whether to decode the message is based on a comparison of a threshold to the priority of the message relative to the first UE.

25. The apparatus of claim 24, wherein the threshold is a dynamic threshold that is based on operating information about a modem processor of the first UE.

26. The apparatus of claim 25, wherein the operating information about the modem processor comprises at least one of a modem performance parameter, a modem power parameter, a modem thermal parameter, a percentage of utilization of the modem processor, a Mega Packet per Second (MPPS) of the modem processor, an operating frequency of the modem processor, a peak current of the modem processor, concurrent operation of the modem processor, or a temperature of the modem processor.

27. The apparatus of claim 24, wherein the threshold is a dynamic threshold that is based on operating information about an application processor of the first UE, wherein the operating information about the application processor comprises at least one of an application performance parameter, an application power parameter, an application thermal parameter, a percentage of utilization of the application processor, a latency of the application processor, a processing flag for a stack of the application processor, or a temperature of the application processor.

28. The apparatus of claim 20, wherein the first UE receives a plurality of messages and determines, at the physical layer, to decode a subset of messages from the plurality of messages, wherein the at least one processor is further configured to:
determine an order for decoding the subset of messages; and
send information about the order for decoding the subset of messages to the higher OSI layers.

29. The apparatus of claim 28, wherein the at least one processor is further configured to:
determine a latency budget for each of the subset of messages, wherein the order is determined based on the latency budget determined for each of the subset of messages, wherein the latency budget for a respective message is based, at least in part, on one or more of:
a first distance between the first UE and a transmitting UE for the respective message,
a first direction of travel of the first UE,
a second direction of travel of the transmitting UE for the respective message,
a first speed of the first UE,
a second speed of the transmitting UE for the respective message, or
a second distance between the first UE and the transmitting UE for the respective message in combination with at least one of the first direction of travel of the first UE.

30. A computer-readable medium storing computer executable code for cellular vehicle-to-everything (C-V2X) wireless communication at a first user equipment (UE), the code when executed by a processor cause the processor to:
receive, at a physical layer, a message from a second UE, the message comprising a control channel and a data channel;
decode, at the physical layer, a subset of fields comprised in the control channel;
determine a priority of the message relative to the first UE based on the subset of fields decoded at the physical layer;
determine, at the physical layer, whether to decode the message based on the priority of the message relative to the first UE; and
forward the message to higher open system interconnection (OSI) layers for a next stage of decoding when a determination is made at the physical layer to decode the message.
